(19) United States
(12) Patent Application Publication
(10) Pub. No.: US 2016/0302382 A1
(43) Pub. Date: Oct. 20, 2016

(54) PET FEEDER APPARATUS

(71) Applicant: CATSBY, INC., NEW YORK, NY (US)

(72) Inventors: LOREN MATTHEW KULESUS, NEW YORK, NY (US); ERIK CHRISTIAN STROM, NEW YORK, NY (US)

(73) Assignee: CATSBY, INC., NEW YORK, NY (US)

(21) Appl. No.: 14/688,079

(22) Filed: Apr. 16, 2015

(51) Int. Cl. A01K 5/01

(52) U.S. Cl. CPC A01K 5/0114

(57) ABSTRACT

The invention features pet feeder apparatus configured to reduce the stress on feline whiskers when the pet feeds on its food. The invention contemplates a first potion that may be spherically or concave indented and configured to supply and/or provide pet food access for a pet. In some aspects, the invention may also include a lower portion which is releasably engaged with the base of the first portion.

### CROSS-REFERENCE TO RELATED APPLICATIONS

This Application claims the benefit of, and is related to, the following provisional patent application: U.S. Provisional Patent Application No. 62/084,013 titled “PET FEEDER APPARATUS,” filed Nov. 25, 2014, which is incorporated herein in its entirety.

### FIELD OF THE INVENTION

The present invention relates, in general, to a pet feeding apparatus, specifically one designed for the reduction of stress on cat whiskers while the cat is feeding.

### BACKGROUND OF THE INVENTION

Straight, high-sided cat food bowls can be harsh on cat whiskers and can lead to a condition called whisker fatigue or whisker stress. Cat whiskers, being ultra sensitive are forced into repeated contact with the straight, near-straight walls and/or tight spaces of the bowls whilst feeding. Such a stressful experience can range from being a daily nuisance to being extremely painful. As a result cats leave uneaten food in the bowl thereby leading to, in some instances, a famished cat, a cat that exhibits food aggression towards its peers (or owners), and/or a cat that picks up its food and eats it off the floor, creating a mess along the way.

As such, there is a need to end or eliminate a cat's mealtime misery. An aspect of an embodiment of the present invention contemplates a wide but shallow dish or apparatus, which provides cats with easy, painless access to their food without requiring them to pull back their whiskers to avoid agonizing contact. Another aspect of an embodiment of the present contemplates a clean, simple design where the apparatus may be made of stainless steel which is easy to maintain and clean.

### SUMMARY OF THE INVENTION

An aspect of an embodiment of the present invention contemplates a pet feeder apparatus having two components or portions, including an upper portion which, in one aspect, may be a stainless steel bowl that nests nicely into the raised upper lip of a lower portion, which, in one aspect, may be a rubber mat. The pet feeder apparatus may, in another aspect of an embodiment of the present invention, may feature a wide and shallow dish, which is configured/designed for cats to access their food without pulling back their whiskers to avoid agonizing contact. The bowl or upper portion, in one aspect, may nest nicely into the upper lip of the lower portion (the rubber mat, in one aspect) which prevents the bowl from sliding, scratching the floor, and helps level a slightly uneven floor.

In an aspect of an embodiment of the present invention the pet feeder apparatus may include an upper portion, having a base, the upper portion having a spherically indented bowl portion where the spherically indented bowl portion may include an annular rim and an outer frame portion around the spherically indented bowl portion. In one aspect, the outer frame portion may extend from the annular rim down to the base of the upper portion and the spherically indented bowl portion may be structurally configured to receive and provide pet food access to a pet. The pet feeder apparatus may also include a lower portion which may be releasably engaged with the base of the upper portion.

In an aspect of an embodiment of the present invention, the configuration of the lower portion may include a lip portion which prevents the upper portion from slipping on a surface and where the lip portion may be releasably engaged or coupled with the base of the upper portion.

In an aspect of an embodiment of the present invention, the upper and lower portions may both be circular in shape.

In an aspect of an embodiment of the present invention, the upper portion may include a spherically indented bowl portion having an annular rim and an outer frame portion around the spherically indented bowl portion. In one aspect, the outer frame portion may extend from the annular rim to the base of the upper portion.

In an aspect of an embodiment of the present invention, the diameter of the outer frame portion may progressively taper from the base of the upper portion to the annular rim of the spherically indented bowl portion of the upper portion.

In an aspect of an embodiment of the present invention, the radius range of the spherically indented bowl portion may be 117±20 mm.

In an aspect of an embodiment of the present invention, the pet feeder apparatus may include a finger hole, with the finger hole being located on the upper portion of the apparatus.

In an aspect of an embodiment of the present invention, the base of the upper portion may have a diameter larger than the diameter of the annular rim of the upper portion.

In an aspect of an embodiment of the present invention, the annular rim may include a lip portion, where the lip portion may extend towards the center of the spherically indented bowl portion. In one aspect, the lip portion may extend towards the center of the spherically indented bowl portion at an angle.

Another aspect of an embodiment of the present invention contemplates a pet feeder apparatus which may include a spherically indented bowl portion having an annular rim, where the spherically indented bowl portion may be configured to receive and provide access to pet food to a pet and an outer frame portion around the spherically indented bowl portion, where the outer frame portion may extend from the annular rim of the spherically indented bowl portion to a base of the outer frame portion.

In an aspect of an embodiment of the present invention, the outer frame portion may be structurally configured to maintain a spherically indented bowl portion having a radius range of 117±20 mm and a depth range of 26±5 mm at the center point of the spherically indented bowl portion.

In another aspect of an embodiment of the present invention the configuration of the base portion may include a friction inducing lip portion which prevents the apparatus from slipping on a surface.

In another aspect of an embodiment of the present invention, the base of the apparatus may have a diameter larger than the diameter of the annular rim of the spherically indented bowl portion.

In another aspect of an embodiment of the present invention the diameter of the outer frame portion may progressively taper from the base of the outer frame portion to the annular rim of the spherically indented bowl portion.

In yet another aspect of an embodiment of the present invention contemplates pet feeder apparatus which may include an upper portion, having a base and being configured to receive and provide access to pet food to a pet and where the upper portion may include a concave indented bowl portion having an annular rim and an outer frame portion around the concave indented bowl portion, the outer frame portion extending from the annular rim to the base of the upper portion and a lower portion releasably engaged with the base of the upper portion.

In yet another aspect of an embodiment of the present invention, the base of the upper portion may have a larger diameter than the diameter of the annular rim of the concave indented bowl portion. In one aspect, the diameter of the outer frame portion may progressively taper from the base of the upper portion to the annular rim of the concave indented bowl portion of the upper portion.

In yet another aspect of an embodiment of the present invention the depth of the concave indented bowl portion of the pet feeder apparatus may be within the range of 26±5 mm at its center point.

In yet another aspect of an embodiment of the present invention the configuration of the lower portion may include a lip portion which releasably couples with the base of the upper portion.

In yet another aspect of an embodiment of the present invention the annular rim may include a lip portion, the lip portion extending towards the center of the concave indented bowl portion.

In yet another aspect of an embodiment of the present invention, the annular rim may include a lip portion, where the lip portion may be angled towards the center of the concave indented bowl portion.

A further aspect of an embodiment of the present invention contemplates a pet feeder apparatus which may include a concave indented bowl portion having an annular rim, where the concave indented bowl portion may be configured to receive and provide access to pet food to a pet and an outer frame portion around the concave indented bowl portion, the outer frame portion extending from the annular rim of the concave indented bowl portion to a base of the concave indented bowl portion, where the base portion may be contiguous with the outer frame portion. In a further aspect of an embodiment of the present invention, the base may be configured to prevent the apparatus from slipping on a surface. In one aspect, this configuration of the base portion may include a lip portion which prevents the apparatus from slipping on a surface. In a further aspect, the apparatus may be circular in shape.

Additional aspects, objectives, features and advantages of the present invention will become apparent from the following description of the preferred embodiments with reference to the attached drawings. The invention has been described in detail with particular reference to certain preferred embodiments thereof, but it will be understood that variations and modifications can be effected within the spirit and scope of the invention.

### BRIEF DESCRIPTION OF THE DRAWINGS

FIGS. 1A-1C illustrate the pet feeder apparatus, showing its components, assembly and different perspective views, according to aspect(s) of embodiment(s) of the present invention.

FIG. 2A illustrates a side perspective view of the pet feeder apparatus, according to aspect(s) of embodiment(s) of the present invention.

FIG. 2B illustrates a top view of the pet feeder apparatus, according to aspect(s) of embodiment(s) of the present invention.

FIG. 2C illustrates another side perspective view of the pet feeder apparatus, according to aspect(s) of embodiment(s) of the present invention.

FIG. 2D illustrates a bottom perspective view of the pet feeder apparatus, according to aspect(s) of embodiment(s) of the present invention.

FIG. 3 illustrates a top view of a bottom portion of the pet feeder apparatus, according to aspect(s) of embodiment(s) of the present invention.

### DETAILED DESCRIPTION OF THE INVENTION

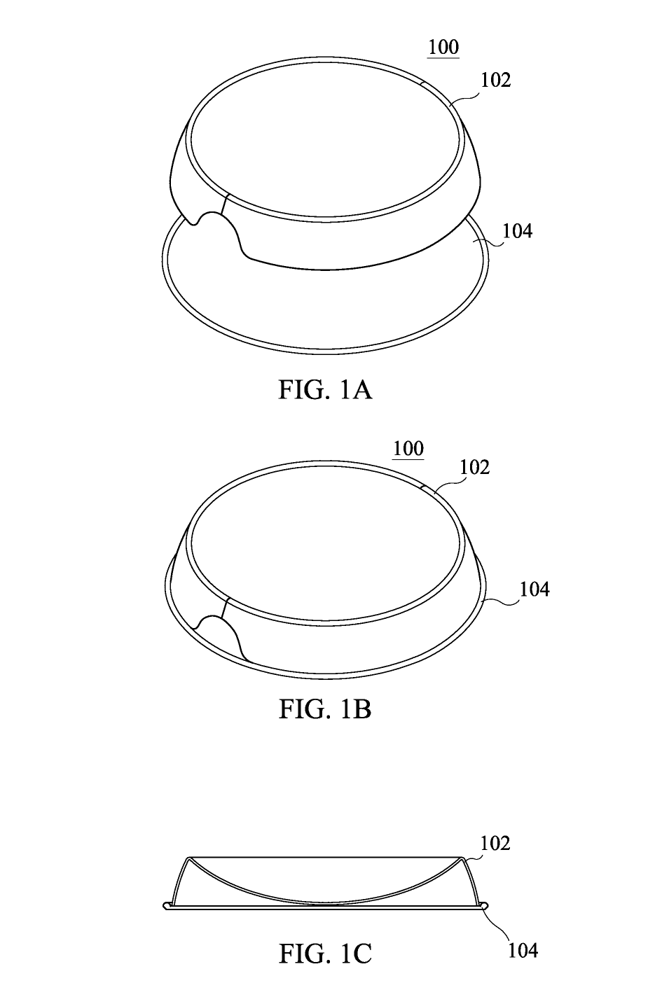

Referring now to FIGS. 1A-1C pet feeder apparatus 100 according to aspect(s) of embodiment(s) of the present invention, is shown. Pet feeder apparatus 100 may include an upper portion 102 which may be structurally configured to releasably couple or mate with lower portion 104 as shown in FIGS. 1B and 1C. Upper portion 102 also may have a portion which both acts as a receptacle for pet food while also providing access to the food by a pet such as a cat.

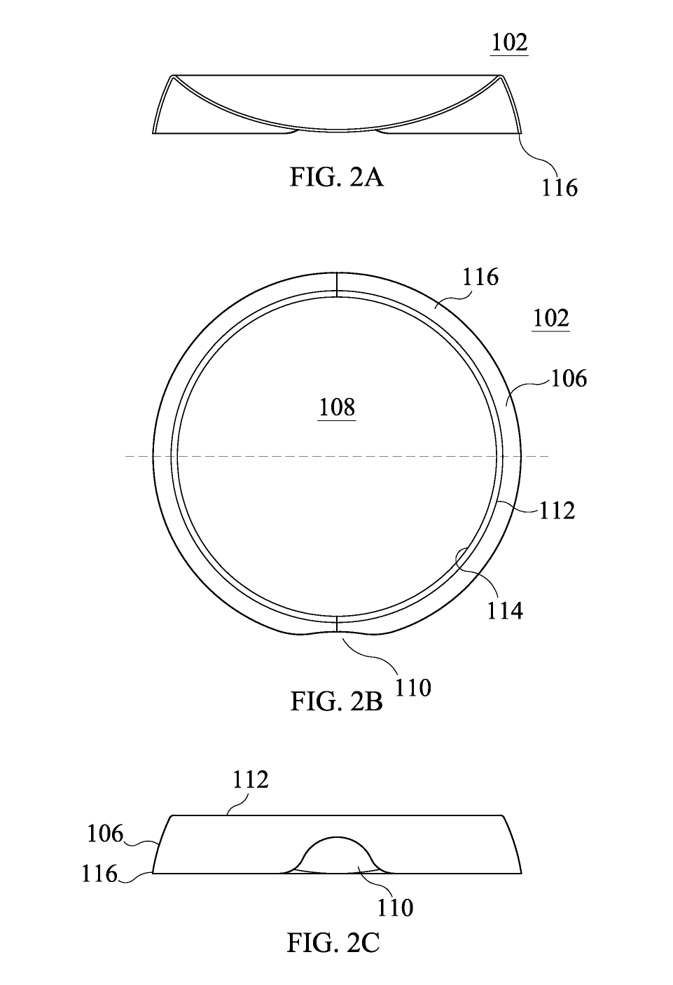

Referring now to FIGS. 2A-2D, FIGS. 2A through 2D respectively show side, top, additional side and bottom views of pet feeder apparatus 100, according to aspects of embodiments of the present invention. Upper portion 102 is further shown having base portion 116 which may be structurally configured, in one aspect of an embodiment of the present invention, to secure upper portion 102′s coupling with lower or bottom portion 104 of pet feeder apparatus 100. Upper portion 102 may also include outer frame portion 106 which encircles food receptacle portion 108 into which pet food may be placed and eaten from by a cat. In one aspect of an embodiment of the present invention, food receptacle portion 108 may be spherically indented. In another aspect of an embodiment of the present invention, food receptacle portion 108 may be concave indented. Food receptacle portion 108 may be structurally designed to prevent whisker fatigue or whisker stress. In one aspect of an embodiment of the present invention, a spherically indented food receptacle portion 108 may have a radius of 117 mm. In another aspect of embodiment of the present invention, the radius of spherically indented food receptacle portion 108 may be within the range of 117 mm±20 mm. While the contemplated aspects of embodiments of the present invention are not limited to this range of values, this range works towards the reduction or elimination of whisker fatigue or whisker stress on cats using pet feeder apparatus 100.

Upper portion 102 may include finger hole 110 which may be used to pick up or lift upper portion 102. Finger hole 110 may also be used to detach upper portion 102 from bottom or lower portion 104 of pet feeder apparatus 100. In one aspect of an embodiment of the present invention, finger hole 110 may have a circular shape. In another aspect, it may be parabolic. In yet another aspect, finger hole 110 may have any other shape.

Upper portion 102 may also include annular rim 112 around the upper periphery of food receptacle portion 108 in aspects where it is spherically indented. Annular rim 112 may include a lip 114 around its edge which, in one aspect of an embodiment of the present invention, helps keep the food within food receptacle portion 108. The depth of food receptacle portion 108 may be obtained by measuring the vertical height between the top of annular portion 112 to the center point bottom of food receptacle portion 108.

In another aspect of an embodiment of the present invention, spherically indented food receptacle portion 108 may have a depth of 26 mm at the center point of the spherically indented bowl portion in order to reduce or eliminate the occurrence of whisker fatigue or whisker stress. In yet another aspect of an embodiment of the present invention, the depth of a spherically indented food receptacle portion 108 may be within the range of 26 mm±5 mm.

In an aspect of an embodiment of the present invention, lip 114 of annular rim 112 may be angled to the horizontal. In one aspect, the horizontal may be defined as the plane on or within which annular rim 112 lies. In one aspect, lip 114 may form angles of 5 degrees above or below the horizontal. In another aspect, lip 114 may form an angle of 0 degrees with the horizontal. In another aspect of an embodiment of the present invention, lip 114 may extend a distance from annular rim 112 and towards the center of the food receptacle portion 108.

In one aspect of an embodiment of the present invention, the diameter of outer frame portion 106 may reduce as one proceeds from base portion 116 up to annular rim 112. In one aspect of an embodiment of the present invention, base portion 116 may have a diameter of 171 mm while annular rim 112 may have a diameter of 150 mm.

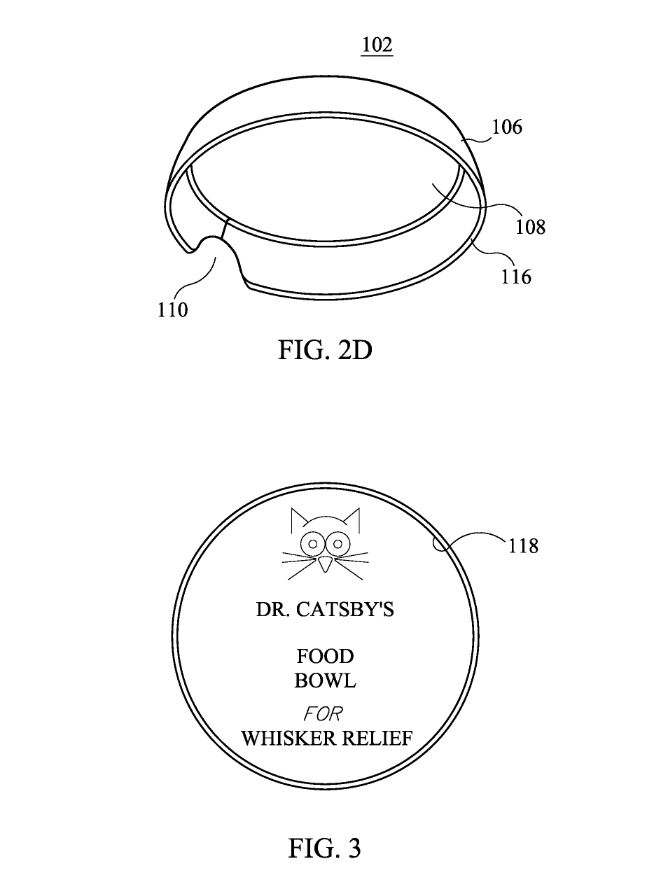

Referring now to FIG. 3, a top view of bottom portion 104 of pet feeder apparatus 100, according to aspect(s) of embodiment(s) of the present invention is shown. Bottom portion 104 of pet feeder apparatus 100 may be circular in design and may include a raised lip 118 around its circumference. Raised lip 118 may be structurally configured to releasably engage and receive base portion 116 of upper portion 102 in order to couple both upper (102) and bottom (104) portions of pet feeder apparatus 100. In one aspect of an embodiment of the present invention, raised lip 118 may be beveled and structurally enabled to tighten itself against base portion 116 to ensure a secure coupling of both the upper and bottom portions of pet feeder apparatus 100. In another aspect of an embodiment of the present invention, bottom portion 104 may be made of rubber. Rubber ensures that pet feeder apparatus 100 does not slide across or scratch the floor surface upon which it is placed. In yet another aspect of an embodiment of the present invention, raised lip 118 may have a height ranging from 3-5 mm

The invention has been described in detail with particular reference to certain preferred embodiments thereof, but it will be understood that variations and modifications can be effected within the spirit and scope of the invention.

What is claimed is:

1. A pet feeder apparatus comprising:
an upper portion, having a base, the upper portion having a spherically indented bowl portion wherein the spherically indented bowl portion comprises of an annular rim and an outer frame portion around the spherically indented bowl portion, the outer frame portion extending from the annular rim down to the base of the upper portion and wherein the spherically indented bowl portion is configured to receive and provide pet food access to a pet; and
a lower portion releasably engaged with the base of the upper portion.

2. The pet feeder apparatus of claim 1 wherein the configuration of the lower portion comprises of a lip portion which releasably couples with the base of the upper portion.

3. The pet feeder apparatus of claim 1 wherein the diameter of the outer frame portion progressively tapers from the base of the upper portion to the annular rim of the spherically indented bowl portion of the upper portion.

4. The pet feeder apparatus of claim 1 wherein the radius range of the spherically indented bowl portion is within the range of 117±20 mm.

5. The pet feeder apparatus of claim 1 further comprising of a finger hole, said finger hole being located on the upper portion of the apparatus.

6. The pet feeder apparatus of claim 1 wherein the annular rim comprises of a lip portion, the lip portion extending towards the center of the spherically indented bowl portion.

7. The pet feeder apparatus of claim 6 wherein the lip portion is angled towards the center of the spherically indented bowl portion.

8. A pet feeder apparatus comprising:
a spherically indented bowl portion having an annular rim, wherein the spherically indented bowl portion is configured to receive and provide pet food access to a pet; and
an outer frame portion around the spherically indented bowl portion, the outer frame portion extending from the annular rim to a base of the upper portion, wherein the base portion is contiguous with the outer frame portion and the outer frame portion maintains a spherically indented bowl portion having a radius range of 117±20 mm and a depth range of 26±5 mm at its center point.

9. The pet feeder apparatus of claim 8 wherein the configuration of the base portion comprises of a friction inducing lip portion which prevents the apparatus from slipping on a surface.

10. The pet feeder apparatus of claim 9 wherein the base of the apparatus has a larger diameter than the diameter of the annular rim of the spherically indented bowl portion.

11. The pet feeder apparatus of claim 10 wherein the diameter of the outer frame portion progressively tapers from the base of the apparatus to the annular rim of the spherically indented bowl portion.

12. The pet feeder apparatus of claim 8 wherein the annular rim comprises of a lip portion, the lip portion extending towards the center of the spherically indented bowl portion.

13. A pet feeder apparatus comprising:
an upper portion, having a base and being configured to receive and provide access to pet food to a pet, wherein the upper portion comprises of a concave indented bowl portion having a rim around the concave indented bowl portion and an outer frame portion around the concave indented bowl portion, the outer frame portion extending from the rim to the base of the upper portion; and
a lower portion releasably engaged with the base of the upper portion.

14. The pet feeder apparatus of claim 13 wherein the depth of the concave indented bowl portion is within the range of 26±5 mm at its center point.

15. The pet feeder apparatus of claim 13 wherein the configuration of the lower portion comprises of a lip portion which releasably couples with the base of the upper portion.

16. The pet feeder apparatus of claim 13 wherein the diameter of the outer frame portion progressively tapers from the base of the upper portion to the annular rim of the concave indented bowl portion of the upper portion.

17. The pet feeder apparatus of claim 13 wherein the annular rim comprises of a lip portion, the lip portion extending towards the center of the concave indented bowl portion.

18. A pet feeder apparatus comprising:
a concave indented bowl portion having an annular rim, wherein the concave indented bowl portion is configured to receive and provide access to pet food to a pet; and
an outer frame portion around the concave indented bowl portion, the outer frame portion extending from the annular rim to a base of the upper portion, wherein the base portion is contiguous with the outer frame portion.

19. The pet feeder apparatus of claim 18 wherein the diameter of the outer frame portion progressively tapers from the base of the outer frame portion to the annular rim of the concave indented bowl portion.

20. The pet feeder apparatus of claim 18 wherein the annular rim comprises of a lip portion, the lip portion extending towards the center of the concave indented bowl portion.
